(19) United States
(12) Patent Application Publication
(10) Pub. No.: US 2017/0323394 A1
(43) Pub. Date: Nov. 9, 2017

(54) SYSTEMS AND METHODS FOR PERFORMING REAL-TIME FORENSIC INVESTIGATION OF RECORDS FOR FINANCIAL INSTITUTIONS AND BUSINESSES

(71) Applicant: Sharon Margaret Campione, Narangba (AU)

(72) Inventor: Sharon Margaret Campione, Narangba (AU)

(21) Appl. No.: 15/589,450

(22) Filed: May 8, 2017

Related U.S. Application Data
(60) Provisional application No. 62/391,643, filed on May 9, 2016.
(60) Provisional application No. 62/495,593, filed on Jan. 16, 2017.

(51) Int. Cl. G06Q 40/00

(52) U.S. Cl. CPC G06Q 40/12

(57) ABSTRACT

The present disclosure relates to systems and methods for monitoring data and financial information in real-time, and noting instances of unusual, and/or potentially fraudulent activity, within a specific business or organization. Specifically, the present systems and methods provide a platform to permit real-time monitoring of business activity, including relating to financial and other proprietary data, without requiring or needing human intervention to operate the system. The present systems and methods also include a notification system for immediately notifying a designated recipients of potentially fraudulent activity within an organization.

This application claims priority to U.S. Provisional Application Ser. No. 62/391,643 filed May 9, 2016, and U.S. Provisional Application Ser. No. 62/495,593, filed Jan. 16, 2017, both of which are incorporated herein in their entireties.

### TECHNICAL FIELD

The present disclosure relates to systems and methods for performing forensic investigations of records, including financial records, for detecting discrepancies in information for financial institutions, businesses and other organizations. More specifically, a system and method is provided for real-time detection and prevention of accounting and data fraud within a financial institution, business or other organization. The full-automated system prevents corruption of data, reports and analysis.

### BACKGROUND

It is a common problem for financial institutions, hospitals, government agencies, businesses and organizations of all sizes to encounter fraud, particularly accounting fraud and misappropriation of financial and other proprietary information. Audits are performed yearly, however, generally by the time an audit is conducted, any identified problem has compounded and may be too late to rectify. There is no current method of continuous, real-time fraud detection in place for businesses and financial institutions. Failure to timely uncover fraudulent activity can result in significant losses in financial data and other proprietary information for any business.

There are various examples of areas of potential fraudulent activity, both financial and other proprietary data. One area includes grant recipients who do not pay their statutory requirements on time; however to an untrained eye a quick review of the balance sheet may indicate a payment was made. Small businesses are potential targets of fraudulent activities, both in terms of financial information and proprietary information, such employee personal information. Yet such activity is not always easy to pinpoint without full, expensive, and time-consuming forensic investigation. For example, an accountant can enter a transaction that appear to be paying a supplier; however the actual funds may go elsewhere. “Ghost employees” are also a common target for would-be fraudsters. It is a known area of concern where payroll officers in large corporations either enter a “ghost employee” or manipulate a wage increase. Employee personal information may be stolen and used to open fraudulent accounts. Such activities can result in tremendous financial losses for any business or organization.

Corporate executives and other business leaders rely on accounting information provided to them; however, information can be improperly manipulated to show desired results. By the time the reports are presented to leadership, it is unclear if these have been directly processed from the accounting software or have been altered. Banks and lenders must also rely on reports that are prepared by the actual lender, again with no certainty that the reports are correct. There is no guarantee the reports accurately present a true picture of how the business is doing. Government departments and many businesses constantly overspend their budgets. Even when reports are produced monthly, it is usually a week or two after month end, and the budget may well have already been fully utilized.

Management teams are reliant on a staff member to produce reports when required, yet management is often frustrated when a staff member due to produce the monthly reports calls in sick, or is already busy with other matters. Human error in generating required reports may also lead to possibly unintended errors. Additionally, creditors may be manipulated at year end to show the bottom line that may not be a true picture, e.g. performance based bonuses are often calculated on profit, yet the “profit” may be overinflated by manipulation.

Sales are an integral part of any business. If astute sales personnel are busy and time constrained, they may overlook that one of the company's best customers has not made a purchase for a significant amount of time. The customer may then be approached by a rival supplier and offered a better deal, potentially resulting in loss of the customer. Yet because a sales teams has not been highlighted to the customer's discrepancy, action cannot be taken to address the issue.

Current sales tracking systems offer report writing modules that are hard to manage and require not only costly training for staff, but also the reliance on that staff member being available. However, if a specific report is urgently needed for a board meeting, and the staff member trained in this area is away on leave, the company is left with a hole in customer service. Other issues relating to staff turnover means having to pay for a new staff member to be trained each time. And audits are a costly necessity for businesses. Auditors have the task of completing a forensic review yearly, which is not only costly, but time consuming for a company's staff who need to attend to auditor's requests, which takes them away from other daily tasks. Again, human error may play a role in the entire reporting process.

Currently there is no system in place to notify leadership of potential internal problems, including unusual fluctuations in spending and/or budgets in real-time. Problems are generally identified only at a period end when reports are produced and reviewed by management. By this time, it may be too later to take corrective action, resulting in significant financial losses for a company.

A need exists for improved systems and methods for monitoring data and financial information in real-time, and noting instances of unusual activity for a specific business or organization. Specifically, a need exists for improved systems and methods that allow for real-time monitoring of business activity, without reliance on human intervention, supervision or operation, and including a notification system for immediately notifying a designated user or users of potentially fraudulent activity.

A further need exists for providing an improved system and method for an automated reporting platform, including investigative software for detecting fraudulent activity within an organization.

A further need exists for providing an improved system and method for monitoring and detecting fraud within an organization, wherein the detection parameters within the system are customizable for a particular situation or organization.

Further, a need exists for an improved system and method of monitoring data and financial activity within an organization, wherein the system automatically monitors activity without the need for human intervention or supervision.

Moreover, a need exists for an improved system and method of monitoring financial data without the need to perform a special audit or full forensic investigation.

Additionally, a need exists for improved systems and methods to prevent fraudulent financial activity within an organization.

Moreover, a need exists for improved systems and methods for preventing real monetary losses from fraudulent activities.

A further need exists for improved systems and methods for quickly and easily alerting a user to potentially fraudulent activity before it reaches a critical level within an organization.

### SUMMARY

The present disclosure relates to systems and methods for monitoring data and financial information in real-time, and noting instances of unusual, and/or potentially fraudulent activity, within a specific business or organization. Specifically, the present systems and methods provide a platform to permit real-time monitoring of financial and proprietary business data and activity, without requiring or needing human intervention to operate the system. The present systems and methods also include a notification system for immediately notifying a designated recipient of potentially fraudulent activity within an organization, so the recipient can take any steps necessary to obviate any potential damage relating to the activity.

To this end, in an embodiment of the present invention, a method of monitoring, comparing and reporting on data, including financial and other proprietary data and activity within an organization, is provided. The method includes the steps of providing an electronic computing device with a computer-readable program code stored therein, the electronic computing device in connection with a server, downloading a set of predetermined financial parameters into the program code of the computing device, entering financial data of the organization as input data into the computing device, comparing the input data with the predefined parameters using a processor within the computing device, and automatically determining whether the input data falls within the predefined parameters. The method further includes the step of generating a report in real-time presenting the results of comparing the entered data with the predetermined parameters

In another embodiment of the present disclosure, a method of monitoring and reporting potentially fraudulent activity within an organization, is provided. The method comprises the steps of providing an electronic computing device with a computer-readable program code stored therein, the electronic computing device in connection with a server of the organization, downloading a set of predetermined parameters into the program code of the computing device, inputting data into the computing device, comparing the input data with the predetermined parameters using a processor within the computing device, and automatically determining whether the input data falls within the predefined parameters.

In yet another embodiment of the present disclosure, a system for providing automated monitoring of financial transactions of an organization for detection of potentially fraudulent activity is provided. The system comprises an electronic computing device with a computer-readable program code stored therein, the electronic computing device connecting with a server of the organization, a processing device operatively coupled to the electronic computing device and the server, wherein the processing device is configured to execute the computer readable code to: provide a set of predetermined financial parameters relating to set limits, accept input of financial data, perform a comparison analysis of the predetermined financial parameters with the input financial date, generate a report based on the analysis, and immediately transmit the report to a target electronic computing device connecting to the organization electronic computing device through the server, wherein the target electronic computing device can receive and project the report in real-time.

Thus, it is an advantage of the present invention to provide systems and methods for monitoring business activity in real-time for immediate detection of potentially fraudulent activity without reliance on human intervention.

Moreover, it is another advantage of the present invention to provide systems and methods for monitoring business activity in real-time and providing a notification system for immediately notifying a designated user or recipient of potentially fraudulent activity within the organization.

Another advantage of the present invention is to provide systems and methods for electronically monitoring financial data within an organization in real-time without the need to perform a special audit or full forensic investigation.

Yet another advantage of the present invention is to provide systems and methods for easily alerting a user through use of an electronic device, to potentially fraudulent activity before the activity reaches a critical level within an organization.

Moreover, another advantage of the present invention is to provide systems and methods for detecting fraud within an organization, wherein the system includes automatic, electronic comparison of input data with predetermined parameters, which eliminates human error and intervention.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a high level process flow chart illustrating the data and fraud monitoring platform of the present disclosure;

FIG. 2 and subpart FIGS. 2a, 2b and 2c illustrate snapshots of a software application of the data and fraud monitoring platform of the present disclosure;

FIG. 3 illustrates a high level process flow chart illustrating an example of a monitoring and transaction review platform of the present disclosure.

### DETAILED DESCRIPTION

The present disclosure relates to systems and methods for monitoring data and financial information in real-time, and immediately reporting instances of unusual activity for a specific business or organization. Specifically, the present systems and methods provide a platform to permit real-time, automated monitoring of business activity, including a notification system for immediately notifying a designated recipient of potentially fraudulent activity within an organization.

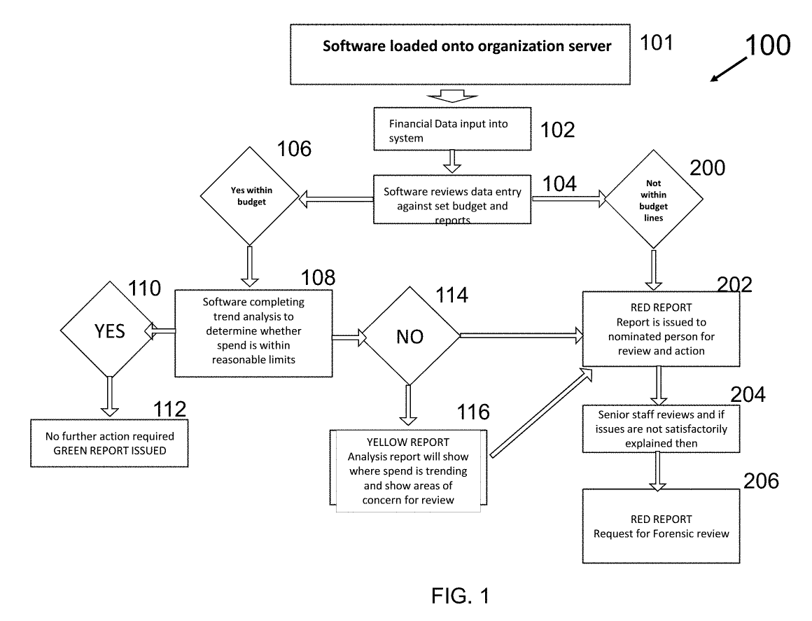

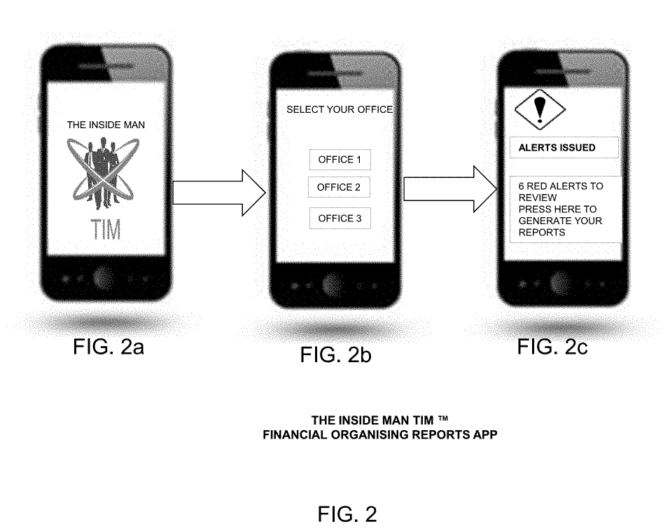

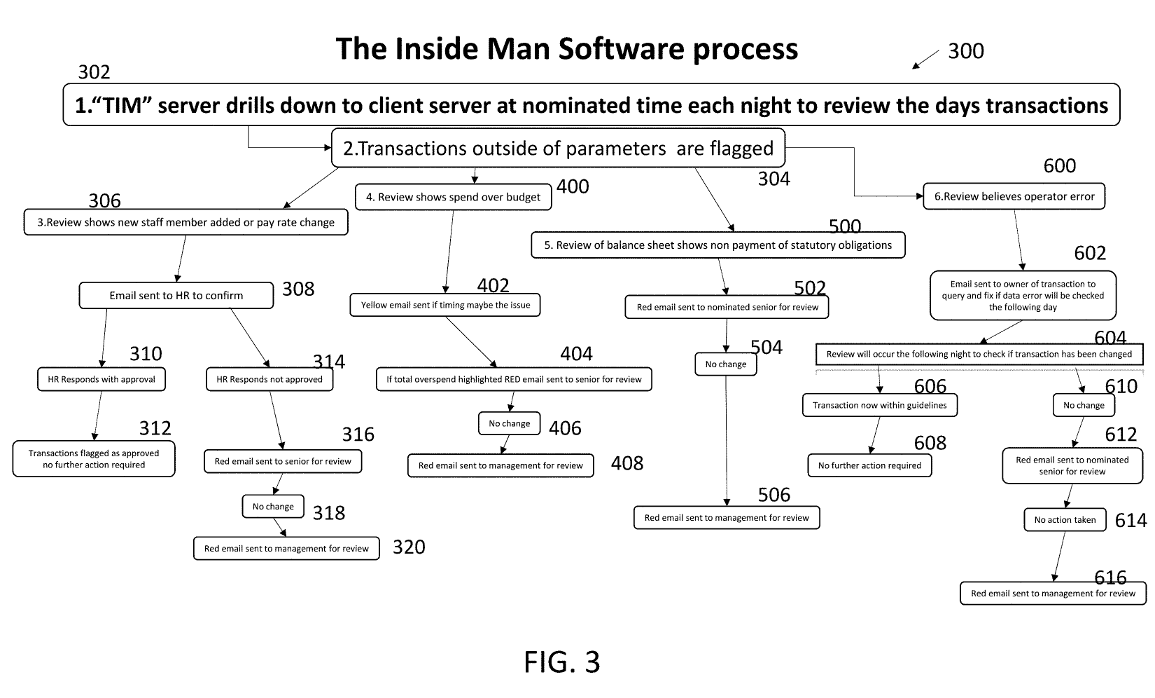

Now referring to the figures, wherein like numerals refer to like parts, FIG. 1 illustrates a high level process flow chart showing an embodiment of the data and fraud monitoring platform of the present disclosure. FIG. 2 illustrates screenshots of a software application useful on a mobile electronic device for in the data and fraud monitoring platform of the present disclosure. FIG. 3 illustrates a high level process flow chart of a monitoring process and transaction review platform of the present disclosure.

As is commonly known, monitoring and detecting instances of fraud, particularly financial fraud, within an organization can be both tedious and costly. Further, organizations can not always afford in terms of time and money to consistently run financial audits; however, detecting instances of fraud only sporadically throughout the year, or during a yearly audit, may be too late and financially detrimental to an organization. Similarly, the loss of proprietary data and information can likewise be detrimental to a business or organization. Therefore, a need exists for monitoring business transactions and activity, including financial and other proprietary data, of an organization preferably on a real-time basis, and without the need for human supervision or action.

The present system and method provides daily, automated management and overview of an entire financial or data system, permitting an organization to be proactive, rather than reactive, to a situation. The present system permits customized set up of desired predetermined parameters and reporting requirements, allowing the software to perform the required monitoring and reporting in real-time without the need for special staffing, and generates reports without human intervention.

Now referring to the figures, FIG. 1 illustrates an embodiment of a high level process flow diagram for a web-based system 100 for a financial fraud monitoring platform, which is housed on an electronic device, including the server 101 of an organization. The system 100 provides at least two routes or avenues 106, 200 useful for detection of potentially fraudulent activity within an organization. To initiate the process, and using a computing device, a user inputs financial date into the system ledger 102. The system 100 reviews and analyzes the data entry against predetermined or preset parameters 104, including for example, preferred budget and spending limits.

In this particular example, the preset parameters include a specific budget and spending limits. However, it should be noted that the preset parameters 104 can be set or customized specifically for the business data and information the organization is monitoring. For example, preset parameters may include typical business transactions for any organization, including but not limited to: the addition of a new employee, a change in pay or salary, regular payments not being made to a set account as required, suspect creditor transactions and payment schedules to creditors, capital purchases, check and/or payment approvals over a nominated value, budget and spending limits and/or unusual spending patterns, etc. essentially any parameters important to a business or organization.

During the analysis, the system 100 determines whether the input data is consistent with the known set of parameters 104. If the input data is consistent with the predetermined parameters, a positive indication 106 is made and the system 100 will then perform a trend analysis 108 to determine whether the data is within reasonable limits. At this point in the process, if the financial data is within the set budget limits (YES 110), a report 112 is issued indicating no further action is required.

If however, during the completion of the trend analysis 108, if the analysis determines that the input data is not within reasonable limits (NO 114) set by the system parameters, then a cautionary report 116 is generated. In this cautionary report 116, analysis will be provided showing where the spending is trending, and also illustrate any potential area or areas of concern that might require additional review. The cautionary report 116 will then be analyzed by the designated recipient who will determine further consideration and whether any potential action needs to be taken. Alternatively, the cautionary report is converted into an alert report 202, which is then reviewed by a designated person—typically a senior staff professional charged with data privacy and fraud prevention responsibilities, a corporate executive, or possibly an outside accounting firm or fraud prevention service—for further review.

Returning to the initial review step 104, if upon review of the input data entry against the predetermined parameters, there is a conclusion that the financial input data is outside of, or otherwise not within the parameters of the budget, for example, a more significant and immediate alert 200 may be issued. The alert report 200 is sent immediately to the designated recipient in charge of reviewing and acting upon the inconsistent and potentially fraudulent report 202. The designated recipient reviews 204 the alert report 202, and if the discrepancies within the report are not explained to a satisfactory level, a further forensic report 206 may be issued. The forensic report includes a request for further in-depth review, including, for example, an official audit.

The present fraud monitoring platform 100 uses a “traffic light” style system for grading the level of report based on the analysis performed by the software program. Just as with a typical traffic light system (Green means “go,” Yellow means “caution,” and Red means “stop), the color of the report indicates the level of urgency of the report in view of a comparison of the input data with the preset parameters within the system. The color of the report also provides an indication of the level of attention the report requires to the user, and also whether follow-up investigation is recommended or required.

For example a “Green Report” 112 indicates that all of the transactions and/or data entered into the system platform 100 have cleared the analysis, and comply with the predetermined parameters, and thus no further action is required. A “Yellow Report” 116 is essentially a warning or cautionary report that the entered data is not within a usual pattern of spending or possibly within a set budget, or just generally outside of other preset parameters. Although the Yellow Report 116 does not signal immediate action or further review is necessary, or that there are instances of actual fraudulent activity, it acts as an initial alert that something appears out of the ordinary and may require further investigation. Thus, a Yellow Report 116 is considered a cautionary or advisory report, and further action and/or investigation is recommended.

The “Red Report” 202 is the most urgent of the three reports. Just as a red spot light indicates an immediate action on the part of a driver, the “Red” report indicates that immediate action and/or review is required on the part of the organization. A “Red” report indicates there are abnormal spending trends, and/or certain transactions are over a preset budget. Therefore, unlike the Green 112 and Yellow Reports 116, the Red Report indicates that fraudulent activity is likely occurring in real-time, and that immediate action should be taken to investigate the activity.

Additionally, the Red Report is initially generated and forwarded electronically to the designated recipient. As noted on FIG. 1, the Red Report 202 is initially reviewed by the designated recipient. This review 204 is done by the designated recipient to determine whether there is a satisfactory explanation for the discrepancies in the data presented. If the designated recipient determines that the discrepancies in the Red Report 202 require further in-depth investigation, a request for official forensic review 206 is made. The reviewing party may be an internal employee of the company assigned to such tasks, or it may be an outside consulting firm specializing in data privacy and security.

An advantage of the present system and method is that fraudulent activity, such as financial embezzlement, can be detected almost immediately, rather than during a yearly audit, where the fraudulent activity could be going on for months or even years. Delayed action on any form of fraudulent activity can be detrimental to any organization. The present system and method provides an ongoing, real-time monitoring and detection system, with customizable parameters.

Although the example provided above focuses on a comparison relating to financial data, it should be understood that the system and method of the present disclosure can also be used for detecting unusual or fraudulent activity in other areas of a business or organizational activities. For example, an appropriate Yellow or Red Report may be issued if a “new” employee is detected in a system, prompting a confirmation request being delivered to human resources (HR) as to whether or not the “new” employee actually exists within the organization. Similarly, “new” creditors and/or suppliers, amendments to any bank details for either employees and/or suppliers, changes to employee salaries—virtually anything out of the ordinary business parameters or operation of an organization—can be monitored within the present system, and appropriate alerts issued. Additionally, appropriate reports may be generated relating to prior month entries or any future transactions, which appear out of the usual course of business.

It should be noted that the systems of the present invention may be implemented on any computing device that may allow the functionality described herein. For example, a business or organization may utilize the system of the present invention through a server using a desktop, laptop or tablet computer that has internet access and the ability to launch the monitoring software program, as described herein. Alternatively, the company or organization may use an electronic mobile device, such as a cellular telephone, an iPhone, a Blackberry device, an Android device, a Windows phone, or any other electronic device useful for interacting with the server of the business or organization and suitable for receiving the appropriate reports and information from the system.

As mentioned, the issuing alert report may be delivered to the designated users or recipients through a software application or “app” loaded onto a mobile device, such as a smartphone or tablet. Referring now to FIG. 2, there is illustrated screenshots of a software app of the present fraud detection system and platform, which is suitable for use on a mobile electronic device. The software app would be loaded onto the personal and/or portable electronic device of the owner or designated user (FIG. 2a). Suitable mobile devices can include a personal computer, laptop computer, smartphone or tablet, or any other electronic device apparent to one of ordinary skill in the art.

As detailed in FIG. 2, using the app, the user would then select the appropriate office for fraud monitoring and notification (FIG. 2b). Appropriate alerts, including the Red, Yellow, Green Reports discussed above, would be issued to the recipient's mobile device, providing immediate notification of a potential problem (FIG. 2c). Depending on the Report issued, the recipient can then act appropriately to immediately address any potential fraud issue, or direct another party to investigate the results, before any potential problem escalates. In this manner, the present system and method permit a business or organization to be proactive, rather than reactive to a fraud or data breach situation.

FIG. 3 provides another example of a monitoring and transaction review process 300 of the present system. In this process, the software program, which is labeled “The Inside Man” or “TIM” software is loaded onto the server of the particular company or organization. At the end of each business day, or on another schedule (day and time) set by the company, the TIM software program is set to automatically review the daily transactions of the organization 302. Preset parameters, i.e., employee information, budget and/or spending limits, creditor information, etc., are loaded onto the server of the company. The software program conducts an analysis and review for any transaction or transactions appearing outside of the preset parameters loaded into the system, and these abnormal transactions are flagged 304.

For example, the employee transaction 306 indicates a change in staff, such as a new employee. The system 300 automatically sends an inquiry 308 to a member of human resources, to confirm whether or not the transaction 306 is appropriate. If the transaction 306 is correct, a response 310 is sent confirming the change, and the transaction 306 is flagged as “approved” and no further action is necessary 312.

In another example, a review shows that a spending transaction 400 is over a set budget parameter. A cautionary email (Yellow Report) is generated alerting a recommendation for further review 402. If the additional review shows a significant budget discrepancy, a higher level message (Red Report) is generated 404 for review by a designated senior staff member. If no further change or action is taken, 406, the Red Report is sent to management 408, or possibly an outside investigative forensic service for review.

Yet another payment transaction 500 involves a review of a balance sheet showing non-payment of a statutory obligation, perhaps a set date for a loan payment. If the required payment is not made, a Red Report alert is sent to the appropriate senior staff member indicating an immediate review 502 should be conducted. If no change is indicated 504, the Red Report is forwarded on to an appropriate member of management 506 for further review and any necessary action.

Yet a further operator error transaction 600 involves a review indicating possible human or operator error. A report is generated in the form of an email sent to the party responsible for the transaction to confirm and/or fix the apparent error 602. During the next scheduled review, the transaction 600 is checked again 604. If the transaction now complies with the set parameters, and is within guidelines, 606, no further action is necessary 608. If however, the transaction is not corrected 610, an alert message (Red Report) is sent to the appropriate staff member indicating further review 612. If a change or correction is not made 614 to comply with the system parameters, a further alert message is forwarded to an appropriate member of management 616 for additional review and any necessary action.

The present systems 100, 300 and methods operate independent of human influence and interaction in determining whether or not the organization's business information and data complies with the preset parameters. In this manner, the system 100, 300 avoids the innocent or intentional manipulation of information that may potentially result in false reports and actions detrimental to an organization, such as financial embezzlement, fraud or stealing of other proprietary information. Additionally, the present systems and methods permit automatic and real-time monitoring of an organization's proprietary data and information, so that any potential issues can be spotted before reaching a level beyond repair and damaging to the organization. Thus, the systems are essentially automatic auditing systems.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A method of monitoring and detecting fraudulent activity in a financial infrastructure of an organization, the method comprising the steps of:
providing an electronic computing device with a computer-readable program code stored therein, the electronic computing device in connection with a server;
downloading a set of predetermined financial parameters into the program code of the computing device,
entering financial data of the organization as input data into the computing device;
comparing the input data with the predefined parameters using a processor within the computing device, and automatically determining whether the input data falls within the predefined parameters.

2. The method of monitoring and detecting fraudulent activity of claim 1, wherein processor compares the entered data with the predetermined parameters in the computing device in real-time.

3. The method of monitoring and detecting fraudulent activity of claim 1, wherein the method further includes the step of generating a data trend report presenting the results of comparing the entered data with the predetermined parameters.

4. The method of monitoring and detecting fraudulent activity of claim 3, wherein the method further includes the step of issuing the data trend report to a computing device of a designated user, wherein the designated user can act on the results if the results show activity outside of the predetermined parameters.

5. The method of monitoring and detecting fraudulent activity of claim 1, wherein the data trend report indicates an activity level of review importance in view of the comparison of the results to the predetermined parameters.

6. The method of monitoring and detecting fraudulent activity of claim 5, wherein a low activity level indicates the input data is within the predetermined parameters.

7. The method of monitoring and detecting fraudulent activity of claim 5, wherein a high activity level indicates the input data outside of the predetermined parameters.

8. The method of monitoring and detecting fraudulent activity of claim 7, wherein the high activity level requires a further step of requesting a follow-up forensic review step.

9. The method of monitoring and detecting fraudulent activity of claim 5, wherein the activity level and report are issued in real-time.

10. A method of monitoring and reporting potentially fraudulent activity within an organization, the method comprising the steps of:
providing an electronic computing device with a computer-readable program code stored therein, the electronic computing device in connection with a server of the organization;
downloading a set of predetermined parameters into the program code of the computing device,
inputting data into the computing device;
comparing the input data with the predetermined parameters using a processor within the computing device, and automatically determining whether the input data falls within the predefined parameters.

11. The method of monitoring and reporting potentially fraudulent activity of claim 10, wherein the set of predetermined parameters are selected from the group consisting of staffing levels, pay increases/decreases, budget and spending limits, creditor transactions and payments, check limits and approvals.

12. The method of monitoring and reporting potentially fraudulent activity of claim 10, wherein the step of comparing the input data with the predetermined parameters further includes a conducting a trend analysis to determine whether the input data is within or outside of the predetermined parameters.

13. The method of monitoring and reporting potentially fraudulent activity of claim 10, wherein the method further includes generating a status level report on the comparison between the input data and the predetermined parameters.

14. The method of monitoring and reporting potentially fraudulent activity of claim 13, wherein the status level report further indicates a designation of urgency requiring a follow-up review of the input data compared to the predetermined parameters.

15. The method of monitoring and reporting potentially fraudulent activity of claim 14, wherein the status level report is generated in real-time.

16. The method of monitoring and reporting potentially fraudulent activity of claim 13, wherein the status level report is transmitted electronically to a target electronic computing device connecting to the organization electronic computing device through the organization's server.

17. The method of monitoring and reporting potentially fraudulent activity of claim 16, wherein the target electronic computing device can receive and display the report in real-time.

18. A system for providing automated monitoring of financial transactions of an organization for detection of potentially fraudulent activity, the system comprising:
an electronic computing device with a computer-readable program code stored therein, the electronic computing device connecting with a server of the organization;
a processing device operatively coupled to the electronic computing device and the server, wherein the processing device is configured to execute the computer readable code to:
provide a set of predetermined financial parameters relating to set budget and spending limits;
accept input of financial data;
perform a comparison analysis of the predetermined financial parameters with the input financial date;
generate a report based on the comparison analysis; and,
immediately transmit the report to a target electronic computing device connecting to the organization electronic computing device through the server, wherein the target electronic computing device can receive and display the report in real-time.
